(19) United States
(12) Patent Application Publication
(10) Pub. No.: US 2024/0308260 A1
(43) Pub. Date: Sep. 19, 2024

(54) THERMOSENSITIVE RECORDING MEDIUM

(71) Applicant: Nippon Paper Industries Co., Ltd., Tokyo (JP)

(72) Inventors: Kenji HIRAI, Tokyo (JP); Masaya TOSAKA, Tokyo (JP); Yuuki INAMURA, Tokyo (JP); Yoshimi MIDORIKAWA, Tokyo (JP)

(21) Appl. No.: 18/282,704

(22) PCT Filed: Mar. 10, 2022
(86) PCT No.: PCT/JP2022/010530

§ 371 Date: Sep. 18, 2023

(30) Foreign Application Priority Data
Mar. 19, 2021 (JP) 2021-045570

(51) Int. Cl. B41M 5/52; C08F 220/18

(52) U.S. Cl. CPC B41M 5/52; C08F 220/1804; C08F 220/1808; B41M 2205/40

(57) ABSTRACT

A thermosensitive recording medium having a thermosensitive recording layer comprising a colorless or pale colored electron donating leuco dye and an electron accepting color developing agent on a substrate, and a protective layer on the thermosensitive recording layer, wherein the thermosensitive recording layer contains at least one kind of urea compound represented by the following general formula (Formula 1) as the electron accepting color developing agent, and wherein the protective layer contains an acrylic resin

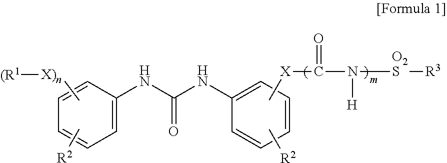

(wherein X represents —O— or —NH—, R¹ represents a hydrogen atom or —SO₂—R³, R³ represents a substituted or unsubstituted alkyl group, an aralkyl group or an aryl group, R² represents a hydrogen atom or an alkyl group, m represents an integer of 0 to 2, and n represents 0 or 1).

### CROSS REFERENCE TO RELATED APPLICATIONS

This application is a 371 U.S. National Phase of International Application No. PCT/JP2022/010530, filed on Mar. 10, 2022, which claims priority to Japanese Patent Application No. 2021-045570, filed Mar. 19, 2021. The entire disclosures of the above applications are incorporated herein by reference.

### TECHNICAL FIELD

The present invention relates to a thermosensitive recording medium for recording image by utilizing a coloring reaction between a colorless or pale colored electron donating leuco dye (referred to as “leuco dye”) and an electron accepting color developing agent (referred to as “color developing agent”), which has an excellent high-speed thermal printing ability, as well as excellent thermal printing run-ability, oil resistance, solvent barrier property, and the like.

### BACKGROUND ART

Thermosensitive recording media are ordinarily prepared by applying the coating solution containing the leuco dye and the color developing agent onto a substrate such as paper, synthetic paper, film, plastic and the like. Thermosensitive recording medium develops color through an instantaneous chemical reaction when heated by a thermal head, hot stamp, hot pen, laser light or the like to yield a recorded image. Such thermosensitive recording media are used extensively in recording media such as facsimile devices, computer terminal printers, automatic ticket dispensers, recorders for meters, receipts at super markets and convenience stores and the like.

In recent years, the use of the thermosensitive recording medium is expanding, such as various ticket, receipts, labels, ATM of Bank, meter reading of gas and electricity, cash vouchers, such as car racing or horseracing betting. Therefore, the thermal recording medium is required to have various performances such as water resistance, plasticizer resistance in the image part, heat resistance of blank part, oil resistance, preservation of image and blank parts under harsh conditions, and the like.

In response to such demands, a thermosensitive recording medium in which water resistance, plasticizer resistance of the image part, heat resistance of blank part, etc. are improved by using a combination of two specific types of color color developing agents (Japanese Patent Application Laid-Open (kokai) No. 2015-80852), and a thermosensitive recording medium in which color density, brightness, and storage stability of printed part etc. are improved by using a urea compound as a color developing agent (International Publication WO2019/044462, Japanese Patent Application Laid-Open (kokai) No. 2020-066148) have been disclosed.

In addition, it is generally known to provide a protective layer on a thermosensitive recording layer to improve storage stability of a thermosensitive recording medium.

It is known to improve the head wearing resistance during thermal printing, the storage stability of printed image and the water resistance of the thermosensitive recording medium by having the thermosensitive recording layer or the protective layer contain a silane-modified acrylic resin (Japanese Patent Application Laid-Open (kokai) No. H05-574, Japanese Patent Application Laid-Open (kokai) No. 2000-238432 etc.).

Furthermore, it is known that the thermosensitive recording medium shows a sufficient water resistance and the like by having the protective layer contain an acrylic resin with a glass transition temperature (Tg) of higher than 50 degree C. and lower than or equal to 95 degree C. (International Publication WO2010-110209 etc.).

Therefore, the object of the present invention is to provide a thermosensitive recording medium having an excellent high-speed thermal printing ability, as well as excellent thermal printing run-ability, oil resistance, solvent barrier property, and the like, among various performances required for the thermosensitive recording medium.

### SUMMARY

As a result of intensive studies, the present inventors have found that the above problems can be solved by having a thermosensitive recording layer contain a specific urea compound as a color developing agent and by having a protective layer provided on the thermosensitive recording layer contain an acrylic resin, and then completed the present invention.

The present invention provides a thermosensitive recording medium having a thermosensitive recording layer comprising a colorless or pale colored electron donating leuco dye and an electron accepting color developing agent on a substrate, and a protective layer on the thermosensitive recording layer, wherein the thermosensitive recording layer contains at least one kind of urea compound represented by the following general formula (Formula 1) as the electron accepting color developing agent, and wherein the protective layer contains an acrylic resin

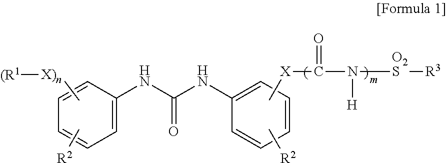

(wherein X represents —O— or —NH—, R¹ represents a hydrogen atom or —SO₂—R³, R³ represents a substituted or unsubstituted alkyl group, an aralkyl group or an aryl group, R² represents a hydrogen atom or an alkyl group, m represents an integer of 0 to 2, and n represents 0 or 1).

### Advantageous Effects of the Invention

According to the present invention, it is possible to provide a thermosensitive recording medium having an excellent high-speed thermal printing ability while having color-developing performance, as well as excellent thermal printing run-ability, oil resistance, solvent barrier property, and the like.

### DETAILED DESCRIPTION

A thermosensitive recording medium of the present invention has a thermosensitive recording layer on a substrate and a protective layer on the thermosensitive recording layer, wherein the thermosensitive recording layer contains a specific urea compound as an electron accepting color developing agent, and the protective layer contains an acrylic resin.

Hereinafter, various materials used in the thermosensitive recording layer of the thermosensitive recording medium of the present invention will be illustrated, however, binders, cross-linking agents, pigments and the like can also be used for other coating layers within the range that does not impair the desired advantages on the above-mentioned problems.

In the thermosensitive recording medium of the present invention, the thermosensitive recording layer contains at least one kind of a urea compound represented by the general formula (Formula 1) as the color developing agent. In the general formula (Formula 1), R³ is preferably a substituted or unsubstituted aryl group, more preferably a group represented by the following formula:

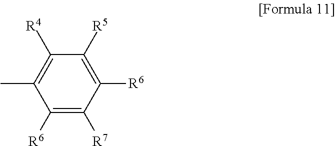

(wherein R⁴ to R⁸ may be identical or different from each other, represent a hydrogen atom, a halogen atom, a nitro group, an amino group, an alkyl group, an alkoxy group, an aryloxy group, an alkylcarbonyloxy group, an arylcarbonyloxy group, an alkylcarbonylamino group, an arylcarbonylamino group, an alkylsulfonylamino group, an arylsulfonylamino group, a monoalkylamino group, a dialkylamino group, or an arylamino group).

The urea compound is preferably selected from the following general formulae (1) to (3).

(1) A first urea compound represented by the following general formula (Formula 2)

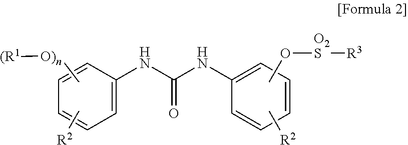

(wherein R¹, R², and R³ are defined as above).
(2) A second urea compound represented by the following general formula (Formula 3)

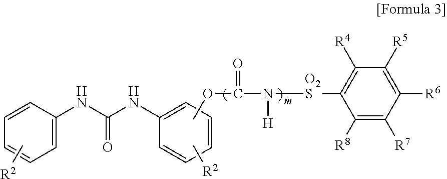

(wherein R² and m are defined as above, and R⁴ to R⁸ are described later). (3) A third urea compound represented by the following general formula (Formula 4)

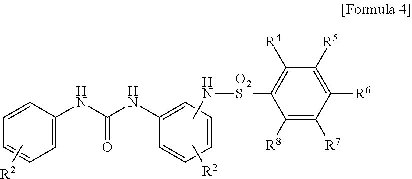

(wherein R² and m are defined as above, and R⁴ to R⁸ are described later).

Furthermore, the urea compound used in the present invention preferably includes at least two kinds of the urea compounds selected from the above-described general formulae (1) to (3). However, in this case, the urea compound is not selected from two or more kinds of each of (1), (2) or (3). That is, the urea compound including at least two kinds is a combination of the first urea compound and the second urea compound, a combination of the first urea compound and the third urea compound, a combination of the second urea compound and the third urea compound, or a combination of the first to third urea compounds represented by (1) to (3).

The first urea compound used in the present invention is represented by the following formula (Formula 2) and is preferably represented by the following formula (Formula 5).

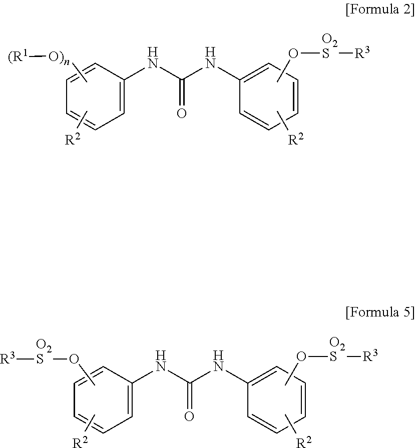

In the general formula (Formula 2), R¹ represents a hydrogen atom or —SO₂—R³, and n represents 0 or 1, preferably 1.

In the above general formula (Formula 2) and general formula (Formula 5), R² represents an alkyl group, an aralkyl group or an aryl group, all of which may be substitute d or unsubstituted. The alkyl group is, for example, a linear, branched or alicyclic alkyl group, preferably having 1 to 12 carbon atoms. The carbon number of the aralkyl group is preferably 7 to 12, and the carbon number of the aryl group is preferably 6 to 12. When these are substituted, the substituent is preferably an alkyl group having 1 to 12 carbon atoms, an alkoxy group having 1 to 12 carbon atoms, an aryl group having 6 to 12 carbon atoms or a halogen atom. Further, the plurality of R2 may be the same or different.

The position of R¹—O— in the benzene ring in the general formula (Formula 2) may be the same or different, and is preferably the 3-position, 4-position or 5-position.

The position of R¹—SO₂—O— in the benzene ring in the general formula (Formula 2) and general formula (Formula 5) may be the same or different, and is preferably the 3-position, 4-position or 5-position.

The alkyl group includes methyl group, ethyl group, n-propyl group, iso-propyl group, n-butyl group, iso-butyl group, t-butyl group, cyclopentyl group, hexyl group, cyclohexyl group, 2-ethylhexyl group, a lauryl group and the like.

The aralkyl group may be an unsubstituted aralkyl group or an aralkyl group substituted by alkyl group, alkoxy group, aralkyl group, aryl group or halogen atom. Examples thereof include benzyl group, 1-phenylethyl group, 2-phenylethyl group, 3-phenylpropyl group, p-methylbenzyl group, m-methylbenzyl group, m-ethylbenzyl group, p-ethylbenzyl group, p-iso-propylbenzyl group, p-t-butylbenzyl group, p-methoxybenzyl group, m-methoxybenzyl group, o-methoxybenzyl group, m, p-di-methoxybenzyl group, p-ethoxy-m-methoxybenzyl group, p-phenylmethylbenzyl group, p-cumylbenzyl group, p-phenylbenzyl group, o-phenylbenzyl group, m-phenylbenzyl group, p-tolylbenzyl group, m-tolylbenzyl group, o-tolylbenzyl group and a p-chlorobenzyl group, and the like.

The aryl group may be an unsubstituted aryl group or an aryl group substituted by alkyl group, alkoxy group, aralkyl group, aryl group or halogen atom. Examples thereof include phenyl group, p-tolyl group, m-tolyl group, o-tolyl group, 2,5-dimethylphenyl group, 2,4-dimethylphenyl group, 3,5-dimethylphenyl group, 2, 3-dimethylphenyl group, 3,4-dimethylphenyl group, mesitylene group, p-ethylphenyl group, p-iso-propylphenyl group, p-t-butylphenyl group, p-methoxyphenyl group, 3,4-dimethoxyphenyl group, p-ethoxyphenyl group, p-chlorophenyl group, 1-naphthyl group, 2-naphthyl group, t-butylated naphthyl group, and the like.

R² represents a hydrogen atom or an alkyl group, preferably a hydrogen atom. The alkyl group is preferably an alkyl group having 1 to 4 carbon atoms, which is, for example, methyl group, ethyl group, propyl group, isopropyl group, butyl group, isobutyl group, sec-butyl group, t-butyl group and the like.

The position of R² in the benzene ring in the general formula (Formula 2) may be the same or different, and is preferably 3-position, 4-position, or 5-position.

The first urea compound of the present invention is more preferably the first urea compound represented by the following general formula (Formula 6).

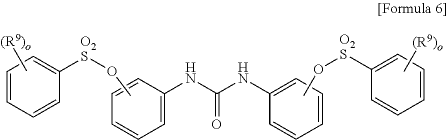

In the general formula (Formula 6), R⁹ is alkyl group or alkoxy group, preferably alkyl group. n represents an integer of 0 to 3, preferably 0 to 2, and more preferably 0 to 1. The number of carbon atoms of the alkyl group is, for example, 1 to 12, preferably 1 to 8, and more preferably 1 to 4.

The position of R⁹ in the benzene ring in the general formula (Formula 6) may be the same or different, and is preferably 3-position, 4-position or 5-position, more preferably 4-position.

Further, the examples of the first urea compound used in the present invention includes, N, N′-di-[3-(benzenesulfonyloxy) phenyl] urea, N, N′-di-[3-(benzenesulfonyloxy)-4-methyl-phenyl] urea, N, N′-di-[3-(benzenesulfonyloxy)-4-ethyl-phenyl] urea, N, N′-di-[3-(benzenesulfonyloxy)-5-methyl-phenyl] urea, N, N′-di-[3-(benzenesulfonyloxy)-4-propyl-phenyl] urea, N, N′-di-[3-(o-toluenesulfonyloxy) phenyl] urea, N, N′-di-[3-(m-toluenesulfonyloxy) phenyl] urea, N, N′-di-[3-(p-toluenesulfonyloxy) phenyl] urea, N, N′-di-[3-(p-toluenesulfonyloxy)-4-methyl-phenyl] urea, N, N′-di-[3-(p-xylenesulfonyloxy) phenyl] urea, N, N′-di-[3-(m-xylenesulfonyloxy) phenyl] urea, N, N′-di-[3-(mesitylene sulfonyloxy) phenyl] urea, N, N′-di-[3-(1-naphthalenesulfonyloxy) phenyl] urea, N, N′-di-[3-(2-naphthalenesulfonyloxy) phenyl] urea, N, N′-di-[3-(p-ethylbenzenesulfonyloxy) phenyl] urea, N, N′-di-[3-(p-propylbenzenesulfonyloxy) phenyl] urea, N, N′-di-[3-(p-isopropylbenzenesulfonyloxy) phenyl] urea, N, N′-di-[3-(pt-butylbenzenesulfonyloxy) phenyl] urea, N, N′-di-[3-(p-methoxybenzenesulfonyloxy) phenyl] urea, N, N′-di-[3-(m-methoxybenzenesulfonyloxy) phenyl] urea, N, N′-di-[3-(o-methoxybenzenesulfonyloxy) phenyl] urea, N, N′-di-[3-(m, p-dimethoxybenzenesulfonyloxy) phenyl] urea, N, N′-di-[3-(p-ethoxybenzenesulfonyloxy) phenyl] urea, N, N′-di-[3-(p-propoxybenzenesulfonyloxy) phenyl] urea, N, N′-di-[3-(p-butoxybenzenesulfonyloxy) phenyl] urea, N, N′-di-[3-(p-cumylbenzylsulfonyloxy) phenyl] urea, N, N′-di-[3-(p-cumylbenzenesulfonyloxy) phenyl] urea, N, N′-di-[3-(o-phenylbenzenesulfonyloxy) phenyl] urea, N, N′-di-[3-(p-phenylbenzenesulfonyloxy) phenyl] urea, N, N′-di-[3-(p-chlorobenzenesulfonyloxy) phenyl] urea, N, N′-di-[4-(benzenesulfonyloxy) phenyl] urea, N, N′-di-[4-(p-toluenesulfonyloxy) phenyl] urea, N, N′-di-[3-(ethanesulfonyloxy) phenyl] urea, N, N′-di-[3-(benzylsulfonyloxy) phenyl] urea, and the like. However, the first urea compound of the present invention is not limited to these.

The second urea compound used in the present invention is represented by the general formula (Formula 3).

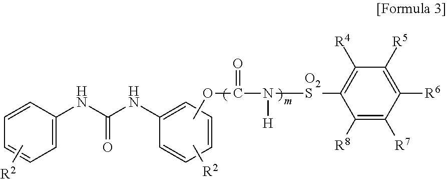

In the general formula (Formula 3), R², R⁴ to R⁸ are defined as above. In the general formula (Formula 3), R⁴ to R⁸ are preferably a hydrogen atom, an alkyl group or an alkyl group. In particular, R⁴, R⁵, R^{T} or R⁸ preferably represent a hydrogen atom, and R⁶ preferably represent a hydrogen atom or an alkyl group, and R⁶ particularly preferably is an alkyl group.

The alkyl group (including the alkyl group in the alkylcarbonyloxy group, the alkylcarbonylamino group, the alkylsulfonylamino group, the monoalkylamino group, and the dialkylamino group) and the aryl group (including the aryl group in the aryloxy group, the arylcarbonyloxy group, the arylcarbonylamino group, the arylsulfonylamino group, and the arylamino group) are defined in the same manner as in the alkyl group and the aryl group in the above general formula (Formula 2).

The alkoxy group may be, for example, a linear, branched or alicyclic alkoxy group, and the number of carbon atoms in the alkoxy group is preferably 1 to 12.

The position of the —O—(CONH) m-SO₂-substituted phenyl group in the benzene ring of the general formula (Formula 3) is preferably at 3-position, 4-position, or 5-position (the same applies to the following general formula (Formula 7) and general formula (Formula 8)).

In the general formula (Formula 3), m represents an integer of 0 to 2, preferably 0 to 1.

The second urea compound of the present invention is preferably a urea compound represented by the following general formula (Formula 7) or general formula (Formula 8).

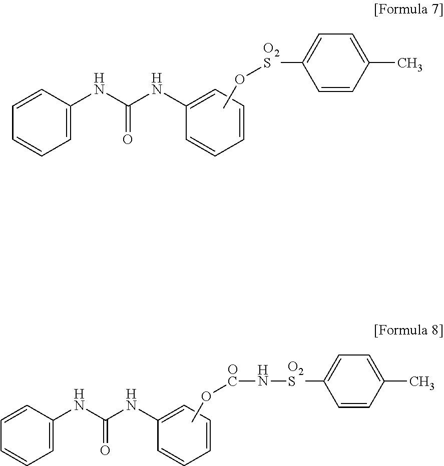

The third urea compound used in the present invention is represented by the general formula (Formula 4).

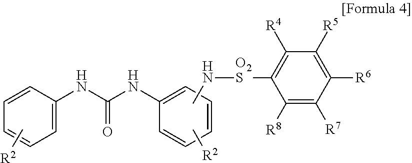

In the general formula (Formula 4), R², R⁴ to R⁸ are defined as above.

The third urea compound is preferably N-[2-(3-phenylureido) phenyl]benzenesulfonamide. The compound is represented by the following formula and is available, for example, under the trade name of NKK 1304 manufactured by Nippon Soda Co., Ltd.

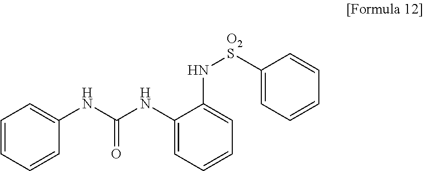 [SMILES: O=C(Nc1ccccc1)Nc1ccccc1NS(=O)(=O)c1ccccc1]

The content (in solid, combined amount when a plurality of urea compounds is contained) of the urea compound in the thermosensitive recording layer of the present invention is from 1.0 to 70.0 weight %, preferably from 5.0 to 65.0 weight %, more preferably 10.0 to 60.0 weight %.

The content of the first urea compound in the thermosensitive recording layer of the present invention is from 1.0 to 50.0 weight %, preferably 5.0 to 40.0 weight %. The content of the second urea compound is from 5.0 to 50.0 weight %, preferably 5.0 to 40.0 weight %. The content of the third urea compound is from 5.0 to 50.0 weight %, preferably 5.0 to 40.0 weight %.

In the case when the thermosensitive recording layer of the present invention contains the first and second urea compounds, the content of the second urea compound in the thermosensitive recording layer is preferably 0.1 to 30.0 weight parts, more preferably 0.5 to 25.0 weight parts, further preferably 1.0 to 20.0 weight parts, especially preferably 2.0 to 15.0 weight parts per 1.0 weight parts of the first urea compound. In addition, in the case when the thermosensitive recording layer of the present invention contains the first and third urea compounds, the content of the third urea compound in the thermosensitive recording layer is preferably 0.1 to 30.0 weight parts, more preferably 0.5 to 25.0 weight parts, further preferably 1.0 to 20.0 weight parts, especially preferably 2.0 to 15.0 weight parts per 1.0 weight parts of the first urea compound. In addition, in the case when the thermosensitive recording layer of the present invention contains the second and third urea compounds, the content of the third urea compound in the thermosensitive recording layer is preferably 0.1 to 30.0 weight parts, more preferably 0.3 to 25.0 weight parts, further preferably 0.5 to 20.0 weight parts, especially preferably 0.7 to 15.0 weight parts per 1.0 weight parts of the second urea compound.

The thermosensitive recording layer of the present invention may contain color developing agent(s) other than the first urea compound and the second urea compound. As such color developing agents, for example, activated clay, attapulgite, colloidal silica, inorganic acidic substances such as aluminum silicate and the like, 4,4′-isopropylidene diphenol, 1,1-bis(4-hydroxyphenyl) cyclohexane, 2,2-bis(4-hydroxyphenyl)-4-methylpentane, 4,4′-dihydroxydiphenyl sulfide, hydroquinone monobenzyl ether, benzyl 4-hydroxybenzoate, 4,4′-dihydroxy diphenyl sulfone, 2,4′-dihydroxy diphenyl sulfone, 4-hydroxy-4′-isopropoxy diphenyl sulfone, 4-hydroxy-4′-n-propoxy diphenyl sulfone, bis(3-allyl-4-hydroxyphenyl) sulfone, 4-hydroxy-4′-methyldiphenyl sulfone, 4-hydroxyphenyl-4′-benzyloxy phenyl sulfone, 3,4-dihydroxyphenyl-4′-methyl phenyl sulfone, 1-[4-(4-hydroxyphenyl-sulfonyl) phenoxy]-4-[4-(4-isopropoxyphenyl sulfonyl) phenoxy]butane, phenol condensate composition described in Japanese Patent Application Public Disclosure No. 2003-154760, aminobenzene sulfonamide derivatives described in Japanese Patent Application Public Disclosure No. H08-59603, bis(4-hydroxyphenyl thioethoxy) methane, 1,5-di(4-hydroxyphenyl thio)-3-oxapentane, butyl bis(p-hydroxyphenyl) acetate, methyl bis(p-hydroxyphenyl) acetate, 1,1-bis(4-hydroxyphenyl)-1-phenyl ethane, 1,4-bis[α-methyl-α-(4′-hydroxyphenyl)ethyl] benzene, 1,3-bis[α-methyl-α-(4′-hydroxyphenyl)ethyl]benzene, di(4-hydroxy-3-methylphenyl) sulfide, 2,2′-thiobis(3-tert-octylphenol), 2,2′-thiobis(4-tert-octylphenol), compounds described in International Publication WO02/081229 or Japanese Patent Application Public Disclosure No. 2002-301873, thiourea compounds such as N,N′-di-m-chlorophenyl thiourea and the like, p-chlorobenzoic acid, stearyl gallate, bis[zinc 4-octyloxy carbonylamino salicylate]dihydrate, 4-[2-(p-methoxyphenoxy) ethyloxy] salicylic acid, 4-[3-(p-tolylsulfonyl) propyloxy] salicylic acid, aromatic carboxylic acids such as 5-[p-(2-p-methoxyphenoxyethoxy) cumyl] salicylic acid, and salts of these aromatic carboxylic acids and polyvalent metals such as zinc, magnesium, aluminum, calcium, titanium, manganese, tin, nickel and the like, and, furthermore, antipirin complexes of zinc thiocyanate and complex zinc salts of terephthal aldehyde acid with other aromatic carboxylic acids and the like may be cited. These color developing agents may be used individually or as a mixture of at least two of them.

1-[4-(4-hydroxyphenyl-sulfonyl) phenoxy]-4-[4-(4-isopropoxyphenyl sulfonyl) phenoxy] butane is available, for example, under the trade name of JKY-214 produced by API Corporation. The phenol condensate composition described in Japanese Patent Application Public Disclosure No. 2003-154760 is available, for example, under the trade name of JKY-224 produced by API Corporation. The compound described in International Publication WO02/081229 is available, for example, under the trade names of NKK-395 and D-100 produced by Nippon Soda Co., Ltd. In addition, high molecular weight aliphatic acid metal complex salts described in Japanese Patent Application Public Disclosure No. H10-258577 and metal chelate type color developing components such as polyvalent hydroxy aromatic compounds and the like may also be present.

In the case when the thermosensitive recording layer contains color developing agent other than the first to third urea compound, the combined amount (in solid) of the the first to third urea compound used is preferably 50 weight % or more, more preferably 80 weight % or more, further preferably 90 weight % or more of the total amount of the color developing agents contained in the thermosensitive recording layer, which contains the first to third urea compound.

All of the leuco dyes well known in the conventional field of pressure sensitive and thermosensitive recording media may be used as the electron donating leuco dye in the present invention. Although the leuco dye is not particularly restricted, triphenylmethane type compounds, fluorane type compounds, fluorene type compounds, divinyl type compounds and the like are preferred as the leuco dye. Specific examples of the typical colorless to pale colored basic colorless leuco dye (leuco dye precursors) are shown below. In addition, these leuco dye precursors may be used individually and also in mixtures of at least two of them.

### <Triphenylmethane Type Leuco Dyes>

3,3-bis(p-Dimethyl aminophenyl)-6-dimethylaminophthalide [alternate name: crystal violet lactone] and 3,3-bis(p-Dimethyl aminophenyl) phthalide [alternate name: malachite green lactone]

### <Fluorane Type Leuco Dyes>

3-Diethylamino-6-methylfluorane, 3-diethylamino-6-methyl-7-anilinofluorane, 3-diethylamino-6-methyl-7-(o,p-dimethylanilino)fluorane, 3-diethylamino-6-methyl-7-chlorofluoran, 3-diethylamino-6-methyl-7-(m-trifluoromethylanilino) fluorane, 3-diethylamino-6-methyl-7-(o-chloroanilino) fluorane, 3-diethylamino-6-methyl-7-(p-chloroanilino) fluorane, 3-diethylamino-6-methyl-7-(o-fluoroanilino) fluorane, 3-diethylamino-6-methyl-7-(m-methylanilino) fluorane, 3-diethylamino-6-methyl-7-n-octylanilino fluorane, 3-diethylamino-6-methyl-7-n-octylamino fluorane, 3-diethylamino-6-methyl-7-benzylamino fluorane, 3-diethylamino-6-methyl-7-dibenzylamino fluorane, 3-diethylamino-6-chloro-7-methyl fluorane, 3-diethylamino-6-chloro-7-anilino fluorane, 3-diethylamino-6-chloro-7-p-methylanilino fluorane, 3-diethylamino-6-ethoxyethyl-7-anilino fluorane, 3-diethylamino-7-methyl fluorane, 3-diethylamino-7-chloro fluorane, 3-diethylamino-7-(m-trifluoromethylanilino) fluorane, 3-diethylamino-7-(o-chloroanilino) fluorane, 3-diethylamino-7-(p-chloroanilino) fluorane, 3-diethylamino-7-(o-fluoroanilino) fluorane, 3-diethylamino-benz[a] fluorane, 3-diethylamino-benz[c] fluorane, 3-dibutylamino-6-methyl-fluorane, 3-dibutylamino-6-methyl-7-anilino fluorane, 3-dibutylamino-6-methyl-7-(o,p-dimethylanilino) fluorane, 3-dibutylamino-7-(o-chloroanilino) fluorane, 3-butylamino-6-methyl-7-(p-chloroanilino) fluorane, 3-dibutylamino-6-methyl-7-(o-fluoroanilino) fluorane, 3-dibutylamino-6-methyl-7-(m-fluoroanilino) fluorane, 3-dibutylamino-6-methyl-chloro fluorane, 3-dibutylamino-6-ethoxyethyl-7-anilino fluorane, 3-dibutylamino-6-chloro-7-anilino fluorane, 3-dibutylamino-6-methyl-7-p-methylanilino fluorane, 3-dibutylamino-7-(o-chloroanilino) fluorane, 3-dibutylamino-7-(o-fluoroanilino) fluorane, 3-di-n-pentylamino-6-methyl-7-anilino fluorane, 3-di-n-pentylamino-6-methyl-7-(p-chloroanilino) fluorane, 3-di-n-pentylamino-7-(m-trifluoromethylanilino) fluorane, 3-di-n-pentylamino-6-chloro-7-anilino fluorane, 3-di-n-pentylamino-7-(p-chloroanilino) fluorane, 3-pyrolidino-6-methyl-7-anilino fluorane, 3-piperidino-6-methyl-7-anilino fluorane, 3-(N-methyl-N-propylamino)-6-methyl-7-anilino fluorane, 3-(N-methyl-N-cyclohexylamino)-6-methyl-7-anilino fluorane, 3-(N-ethyl-N-cyclohexylamino)-6-methyl-7-anilino fluorane, 3-(N-ethyl-N-xylylamino)-6-methyl-7-(p-chloroanilino) fluorane, 3-(N-ethyl-p-toluidino)-6-methyl-7-anilino fluorane, 3-(N-ethyl-N-isoamylamino)-6-methyl-7-anilino fluorane, 3-(N-ethyl-N-isoamylamino)-6-chloro-7-anilino fluorane, 3-(N-ethyl-N-tetrahydrofurfurylamino)-6-methyl-7-anilino fluorane, 3-(N-ethyl-N-isobutylamino)-6-methyl-7-anilino fluorane, 3-(N-ethyl-N-ethoxypropylamino)-6-methyl-7-anilino fluorane, 3-cyclohexylamino-6-chloro fluorane, 2-(4-oxahexyl)-3-dimethylamino-6-methyl-7-anilino fluorane, 2-(4-oxahexyl)-3-diethylamino-6-methyl-7-anilino fluorane, 2-(4-oxahexyl)-3-dipropylamino-6-methyl-7-anilino fluorane, 2-methyl-6-o-(p-dimethylaminophenyl) aminoanilino fluorane, 2-methoxy-6-p-(p-dimethylaminophenyl) aminoanilino fluorane, 2-chloro-3-methyl-6-p-(p-phenylaminophenyl) aminoanilino fluorane, 2-chloro-6-p-(p-dimethylaminophenyl) aminoanilino fluorane, 2-nitro-6-p-(p-diethylaminophenyl) aminoanilino fluorane, 2-amino-6-p-(p-diethylaminophenyl) aminoanilino fluorane, 2-diethylamino-6-p-(p-diethylaminophenyl) aminoanilino fluorane, 2-phenyl-6-methyl-6-p-(p-phenylaminophenyl) aminoanilino fluorane, 2-benzyl-6-p-(p-phenylaminophenyl) aminoanilino fluorane, 2-hydroxy-6-p-(p-phenylaminophenyl)aminoanilino fluorane, 3-methyl-6-p-(p-dimethylaminophenyl) aminoanilino fluorane, 3-diethylamino-6-p-(p-diethylaminophenyl) aminoanilino fluorane, 3-diethylamino-6-p-(p-dibutylaminophenyl) aminoanilino fluorane and 2,4-dimethyl-6-[(4-dimethylamino) anilino] fluorane.

### <Fluorene Type Leuco Dye>

3,6,6-Tris(dimethylamino) spiro[fluorane-9,3′-phthalide] and 3,6,6′-tris (diethylamino) spiro[fluorane-9,3′-phthalide].

### <Divinyl Type Leuco Dyes>

3,3-bis-[2-(p-dimethylaminophenyl)-2-(p-methoxyphenyl) ethenyl]-4,5,6,7-tetrabromophthalide, 3,3-bis-[2-(p-dimethylaminophenyl)-2-(p-methoxyphenyl) ethenyl]-4,5,6,7-tetrachlorophthalide, 3,3-bis-[1,1-bis (4-pyrrolidinophenyl) ethylene-2-yl] 4,5,6,7-tetra-bromophthalide, 3,3-bis-[1-(4-methoxyphenyl)-1-(4-pyrrolidinophenyl) ethylene-2-yl]-4,5,6,7-tetrachlorophthalide

### <Others>

3-(4-Diethylamino-2-ethoxyphenyl)-3-(1-ethyl-2-methylindol-3-yl)-4-azaphthalide, 3-(4-diethylamino-2-ethoxyphenyl)-3-(1-octyl-2-methylindol-3-yl)-4-azaphthalide, 3-(4-cyclohexyl ethylamino-2-methoxyphenyl)-3-(1-ethyl-2-methylindol-3-yl)-4-azaphthalide, 3,3-bis(1-ethyl-2-methylindol-3-yl)phthalide, 3,6-bis(diethylamino)fluorane-7-(3′-nitroanilinolactam, 3,6-bis(diethylamino)fluorane-y-(4′-nitro) anilinolactam, 1,1-bis-[2′,2′,2″,2″-tetrakis-(p-dimethylaminophenyl)-ethenyl]-2,2-dinitrilethane, 1,1-bis-[2′,2′,2″,2″-tetrakis-(p-dimethylaminophenyl)-ethenyl]-2-8-naphthoylethane, 1,1-bis-[2′,2′,2″,2″-tetrakis-(p-dimethylaminophenyl)-ethenyl]-2,2-diacetylethane and bis-[2,2,2′,2′-tetrakis-(p-dimethylaminophenyl)-ethenyl]-methylmalonic acid dimethyl ester.

The previously well known sensitizers may be used as the sensitizer in the thermosensitive recording medium of the present invention. As such sensitizers, aliphatic acid amides such as stearic acid amide, palmitic acid amide and the like, ethylene bis-amide, montan acid wax, polyethylene wax, 1,2-di-(3-methylphenoxy) ethane, p-benzyl biphenyl, 6-benzyloxy naphthalene, 4-biphenyl-p-tolyl ether, m-terphenyl, 1,2-diphenoxyethane, dibenzyl oxalate, di(p-chlorobenzyl) oxalate, di(p-methylbenzyl) oxalate, dibenzyl terephthalate, benzyl p-benzyloxy benzoate, di-p-tolyl carbonate, phenyl-a-naphthyl carbonate, 1,4-diethoxynaphthalene, 1-hydroxy-2-naphthoic acid phenyl ester, o-xylene-bis-(phenyl ether), 4-(m-methyl phenoxymethyl) biphenyl, 4,4′-ethylene dioxy-bis-benzoic acid dibenzyl ester, dibenzoyloxy methane, 1,2-di(3-methylphenoxy) ethylene, bis[2-(4-methoxy-phenoxy) ethyl] ether, methyl p-nitrobenzoate, phenyl p-toluene sulfonate, o-toluenesulfonamide, p-toluenesulfonamide, and the like may be listed as examples. These sensitizers may be used individually and as mixtures of at least two of them.

As a pigment used in the present invention, kaolin, calcined kaolin, calcium carbonate, aluminum oxide, titanium oxide, magnesium carbonate, aluminum silicate, magnesium silicate, calcium silicate, aluminum hydroxide, silica and the like may be used. These pigments may be used in combinations depending on the required quality.

As the binder used in the present invention, completely saponified polyvinyl alcohol, partially saponified polyvinyl alcohol, modified polyvinyl alcohols such as acetoacetylated polyvinyl alcohol, carboxyl-modified polyvinyl alcohol, amide-modified polyvinyl alcohol, sulfonic acid-modified polyvinyl alcohol, butyral-modified polyvinyl alcohol, olefin-modified polyvinyl alcohol, nitrile-modified polyvinyl alcohol, pyrolidone-modified polyvinyl alcohol, silicone-modified polyvinyl alcohol, other modified polyvinyl alcohol, hydroxyethyl cellulose, methyl cellulose, ethyl cellulose, carboxymethyl cellulose,-styrene-maleic anhydride copolymer, styrene-butadiene copolymer, cellulose derivatives such as ethyl cellulose and acetyl cellulose, casein, gum Arabic, oxidized starch, etherified starch, dialdehyde starch, esterified starch, polyvinyl chloride, polyvinyl acetate, polyacrylamide, polyacrylic acid ester, polyvinyl butylal, polystyrol and their copolymers, silicone resins, petroleum resins, terpene resins, ketone resins, cumaron resins and the like may be listed as examples. The polymeric substances may be used upon dissolving them in a solvent such as water, alcohol, ketones, esters, hydrocarbons and the like or upon emulsifying or dispersing into a paste in water or other media. These polymeric materials may also be used in combinations according to the qualities demanded.

As the lubricant used in the present invention, fatty acid metal salts such as zinc stearate, calcium stearate, and the like, waxes, silicone resins, and the like may be cited.

Stabilizing agents that improve oil resistance of recorded images and the like, such as 4,4′-butylidene (6-t-butyl-3-methylphenol), 2,2′-di-t-butyl-5,5′-dimethyl-4,4′-sulfonyl diphenol, 1,1,3-tris (2-methyl-4-hydroxy-5-cyclohexylphenyl) butane, 1,1,3-tris (2-methyl-4-hydroxy-5-t-butylphenyl) butane and the like may also be added in the range that does not adversely affect the desired effects for the problems described above.

In addition, a benzophenone type and triazole type UV absorbers, dispersion agent, de-foaming agent, antioxidant, fluorescent dye and the like may also be used.

The types and amounts of the leuco dye, color developing agent, sensitizer and other various ingredients used in the thermosensitive recording medium of the present invention may be determined according to the required performance and printability. Although the amounts of the color developing agent, the sensitizer, the pigment, the stabilizing agent and the other ingredients are not particularly restricted, from 0.5 parts to 10 parts of the color developing agent, from 0.1 parts to 10 parts of the sensitizer, from 0.5 parts to 20 parts of the pigment, from 0.01 parts to 10 parts of the stabilizing agent and from 0.01 parts to 10 parts of the other ingredients are ordinarily used per 1 part of the leuco dye. The content (in solid) of the binders in the thermosensitive recording layer is suitably around from 5 to 25 weight %.

The leuco dye, the color developing agent and the other materials added as needed are finely ground into particles with several microns or smaller in size, by using a grinder or a suitable emulsification device such as a ball mill, attritor, sand grinder and the like. The coating solutions are prepared by adding a binder and various additives to these depending on the objective. Water, alcohol and the like can be used as the solvent for the coating solution and the content (in solid) of the coating solution is about from 20 to 40 weight %.

In the thermosensitive recording medium of the present invention, the protective layer is further provided on the thermosensitive recording layer, and the protective layer contains an acrylic resin.

In the present invention, as the acrylic resin, a silane-modified acrylic resin or an acrylic resin having a high Tg is used.

The silane-modified acrylic resin used in the present invention is an aqueous resin emulsion obtained by multi-step emulsion polymerization of plural types of polymerizable unsaturated monomers in the presence of a surfactant.

The silane-modified acrylic resin is an aqueous emulsion of core-shell type particles, wherein the core-shell type particle comprises (i) a core comprising copolymer A obtained by polymerizing the following (a1), (a2) and (a3) components in the presence of (b) component, and (ii) a shell comprising copolymer B obtained by polymerizing the following (a1) and (a2) components in the presence of (b) component.
(a1) at least one type of (meth) acrylic acid ester
(a2) a monomer having an alkoxysilyl group and an ethylenic double bond
(a3) a monomer having a carboxyl group and an ethylenic double bond
(b): a polymerizable surfactant comprising a sulfate having an allyl group and a polyoxyethylene chain.

The copolymer A may be prepared by adding a styrene monomer to the (a1), (a2) and (a3) components and polymerizing these in the presence of (b) component, and/or the copolymer B may be prepared by adding a styrene monomer to the (a1) and (a2) components and polymerizing these in the presence of (b) component.

<(a1) at Least One (Meth) Acrylic Acid Ester>

In the present specification, “(meth) acrylic acid” means both acrylic acid and methacrylic acid, and also means including at least one of acrylic acid and methacrylic acid.

“(Meth) acrylic acid ester” means an ester of (meth) acrylic acid, that is, (meth) acrylate. (Meth) acrylate indicates both acrylate and methacrylate, and also means containing at least one of acrylate and methacrylate.

It is noted that “(meth) acrylate” does not include vinyl esters having a structure in which a vinyl group and oxygen are bonded, such as vinyl acetate, in the present specification.

Specific examples of (meth) acrylate include (meth) acrylic acid alkyl esters such as methyl (meth) acrylate, ethyl (meth) acrylate, propyl (meth) acrylate, isopropyl (meth) acrylate, butyl (meth) acrylate, 2-ethylhexyl (meth) acrylate, pentyl (meth)acrylate, hexyl (meth) acrylate, cyclohexyl (meth) acrylate, octyl (meth) acrylate, decyl (meth) acrylate, dodecyl (meth) acrylate, tridecyl (meth) acrylate, octadecyl (meth) acrylate, behenyl (meth) acrylate, docosyl (meth) acrylate, etc.; (meta) acrylic acid hydroxy alkyl ester such as 2-hydroxyethyl (meth) acrylate, 2-hydroxybutyl (meth) acrylate, 2-hydroxypropyl (meth) acrylate, etc. and the like.

These may be used individually or as a mixture of at least two of them.

In the embodiment of the present invention, the (meth) acrylic acid ester is preferably (meth) acrylic acid alkyl ester, and is specifically methyl methacrylate (MMA), 2-ethylhexyl acrylate (2EHA), n-butyl acrylate (n-BA), n-butyl methacrylate (n-BMA), cyclohexyl methacrylate (CHMA) and the like, but the (meth) acrylic acid ester is not limited to these.

<(a2) a Monomer Having an Alkoxysilyl Group and an Ethylenic Double Bond>

The monomer having an alkoxysilyl group and an ethylenic double bond refers to a compound capable of imparting an alkoxysilyl group to an aqueous resin emulsion resin obtained by an emulsion polymerization reaction, and is not particularly limited as long as the aqueous resin emulsion of the present invention can be obtained.

The monomer having an alkoxysilyl group and an ethylenic double bond has both an alkoxysilyl group and an ethylenic double bond, and the alkoxysilyl group and the ethylenic double bond may be bonded, for example, through ester bond, amide bond, alkylene or the like.

The “alkoxysilyl group” refers to a silicon-containing functional group that brings a hydroxyl group (Si—OH) by hydrolysis, which binds to silicon. The “alkoxysilyl group” includes, for example, trimethoxysilyl group, triethoxysilyl group, dimethoxysilyl group, dimethoxymethylsilyl group, diethoxysilyl group, monoethoxysilyl group and monomethoxysilyl group, etc. In particular, trimethoxysilyl group and triethoxysilyl group are preferable.

As used herein, the term “ethylenic double bond” refers to a carbon atom-to-carbon double bond that can undergo a polymerization reaction (for example, radical polymerization). Examples of the functional group having such an ethylenic double bond include vinyl group (CH₂═CH—), (meth) allyl group (CH₂═CH—CH₂— and CH₂═C (CH₃)—CH₂—), (meta) acryloyloxy group (CH₂═CH—COO— and CH₂═C (CH₃)—COO—), (meth) acryloyloxyalkyl group (CH₂═CH—COO—R— and CH₂═C (CH₃)—COO—R—) and —COO—CH═CH—COO— and the like.

It is noted that the monomer having an alkoxysilyl group and an ethylenic double bond is not included in the category of the above-mentioned (meth) acrylic acid ester.

It is possible to exemplify, as the monomer having an alkoxysilyl group and an ethylenic double bond, a compound represented by the following formula (1):

R¹¹Si(OR1²)(OR1³)(OR1⁴) (1)

wherein, in the formula (1), R¹¹ is a functional group having an ethylenic double bond, R¹², R¹³ and R¹⁴ are an alkyl group having 1 to 5 carbon atoms, and R¹², R¹³ and R¹⁴ may be the same or different from each other.

Examples of the functional group having an ethylenic double bond for R¹¹ include vinyl group, (meth)allyl group, (meth)acryloyloxy group, 2-(meth)acryloyloxyethyl group, 2-(meth)acryloyloxypropyl group, 3-(meth)acryloyloxypropyl group, 2-(meth)acryloyloxybutyl group, 3-(meth)acryloyloxybutyl group and 4-(meth)acryloyloxybutyl.

Examples of the alkyl group having 1 to 5 carbon atoms for R¹², R13 and R¹⁴ include linear or branched alkyl groups such as methyl group, ethyl group, n-propyl group, isopropyl group, n-butyl group, isobutyl group, sec-butyl group, t-butyl group, n-pentyl group and the like. Examples of the “monomer having an alkoxysilyl group and an ethylenic double bond” include vinyltrialkoxysilanes such as vinyltrimethoxysilane, vinyltriethoxysilane and vinyltri-n-butoxysilane.

Specifically, 3-(meth)acryloyloxypropyltrimethoxysilane and 3-(meth)acryloyloxypropyltriethoxysilane are preferable, and 3-(meth)acryloyloxypropyltrimethoxysilane is particularly preferable.

These monomers having an alkoxysilyl group and an ethylenic double bond can be used alone or in combination.

<(a3) a Monomer Having a Carboxyl Group and an Ethylenic Double Bond>

Examples of a monomer having a carboxyl group include (meth) acrylic acid. As mentioned above, (meth) acrylic acid means both acrylic acid and methacrylic acid. It is particularly preferable to use acrylic acid as the (meth) acrylic acid.

The “ethylene double bond” is as described above.

### <(b) a Polymerizable Surfactant Comprising a Sulfate Having an Allyl Group and a Polyoxyethylene Chain>

Examples of the sulfate having an allyl group and a polyoxyethylene chain include a sulfate ester ammonium salt having an allyl group and a polyoxyethylene chain, a sulfate ester sodium salt having an allyl group and a polyoxyethylene chain, and a sulfate ester potassium salt having an allyl group and a polyoxyethylene chain. Specifically, it is possible to exemplify: a polyoxyethylene-1-(allyloxymethyl)alkyl ether sulfate ester ammonium salt, a polyoxyethylene-1-(allyloxymethyl)alkyl ether sulfate ester sodium salt, a polyoxyethylene-1-(allyloxymethyl)alkyl ether sulfate ester potassium salt; an α-[1-[(allyloxy)methyl]-2-(nonylphenoxy)ethyl]-6-polyoxyethylenesulfate ester ammonium salt, an α-[1-[(allyloxy)methyl]-2-(nonylphenoxy)ethyl]-ω-polyoxyethylenesulfate ester sodium salt, an α-[1-[(allyloxy)methyl]-2-(nonylphenoxy)ethyl]-ω-polyoxyethylenesulfate ester potassium salt; and the like. These sulfate may be used alone or in combination.

The sulfate having an allyl group and a polyoxyethylene chain according to the present invention is preferably a ammonium sulfate, namely, a polyoxyethylene-1-(allyloxymethyl)alkyl ether sulfate ester ammonium salt and an α-[1-[(allyloxy)methyl]-2-(nonylphenoxy)ethyl]-ω-polyoxyethylenesulfate ester ammonium salt are preferable, and especially a polyoxyethylene-1-(allyloxymethyl)alkyl ether sulfate ester ammonium salt is most preferable.

Examples of commercially available products of the sulfate having an allyl group and a polyoxyethylene chain include “AQUALON KH-10 (trade name)”: polyoxyethylene chain length of 10) and “AQUALON KH-1025 (trade name)”: 25% aqueous solution of AQUALON KH-10) manufactured by Dai-ichi Kogyo Seiyaku Co., Ltd. as the polyoxyethylene-1-(allyloxymethyl)alkyl ether sulfate ester ammonium salt; and “Adecaria Soap SR-1025 (trade name)” manufactured by Asahi Denka Co., Ltd. as the α-[I1-[(allyloxy)methyl]-2-(nonylphenoxy)ethyl]-ω-polyoxyethylenesulfate ester ammonium salt.

In the embodiment of the present invention, as long as the objective aqueous resin emulsion can be obtainable, the polymerizable unsaturated monomer may include “other monomers”. Other monomers mean monomers other than the (meth)acrylic acid ester, the monomer having an alkoxysilyl group and an ethylenic double bond, and the monomer having a carboxyl group.

Examples of “other monomers” include, but are not limited to: styrene-based monomers such as styrene and styrenesulfonic acid; and acrylamides such as (meth)acrylamide and diacetone (meth)acrylamide.

### <Multi-Step Emulsion Polymerization>

The silane-modified acrylic resin (i.e. aqueous resin emulsion) according to the present invention is obtainable by multi-step emulsification polymerization of a polymerizable unsaturated monomer in the presence of a surfactant.

In an embodiment of the present description, the polymerizable unsaturated monomers undergo emulsification polymerization in a plurality of steps (substantially two steps).

The polymerizable unsaturated monomers (above mentioned a1, a2, a3 and b) used at the polymerization other than the final step is referred to as the polymerizable unsaturated monomer A, and thus obtained polymer is referred to as the copolymer A. And the polymerizable unsaturated monomers (above mentioned a1, a2 and b) used at the final step of the polymerization is referred to as the polymerizable unsaturated monomer B, and thus obtained polymer is referred to as the copolymer B.

The aqueous resin emulsion finally obtained by multi-step emulsion polymerization can be obtained by polymerizing the polymerizable unsaturated monomer B with the pre-emulsion obtained by polymerization of the polymerizable unsaturated monomer A.

The aqueous resin emulsion obtained by the multi-step emulsion polymerization has a multi-layer structure (i.e. core shell).

In the present invention, the polymerizable unsaturated monomer used for the multi-step emulsion polymerization includes a polymerizable unsaturated monomer A used in a step other than the final step and a polymerizable unsaturated monomer B used in the final step. The weight ratio of the polymerizable unsaturated monomer B to the polymerizable unsaturated monomer A (polymerizable unsaturated monomer B/polymerizable unsaturated monomer A) is preferably 30/70 to 70/30, particularly preferably 40/60 to 60/40.

When the weight ratio of (the polymerizable unsaturated monomer B to the polymerizable unsaturated monomer A is within the above ratio, the aqueous resin composition (i.e. aqueous resin emulsion) according to the present invention is excellent in balance between coatability and durability (water resistance, alcohol resistance, ester-based solvent resistance and plasticizer resistance).

The ratio of the a2 polymerizable unsaturated monomer is preferably 0.05 to 1.0 weight %, more preferably 0.4 to 0.8 weight %, and the ratio of the a3 polymerizable unsaturated monomer is preferably 0.5 to 10 weight %, more preferably 2.0 to 6.0 weight %, of the combined weight of the polymerizable unsaturated monomers of a1, a2 and a3 in the copolymer A. While the balance is a1 polymerizable unsaturated monomer, the ratio of the a1 polymerizable unsaturated monomer of the combined weight of the above a1, a2, and a3 polymerizable unsaturated monomers is preferably 89 to 99 weight %, more preferably 90 to 98 weight %.

The ratio of the a2 polymerizable unsaturated monomer is preferably 0.01 to 1.0 weight %, more preferably 0.1 to 0.4 weight % of the combined weight of the polymerizable unsaturated monomers of a1 and a2 in the copolymer B. While the balance is a1 polymerizable unsaturated monomer, the ratio of the a1 polymerizable unsaturated monomer of the combined weight of the above a1 and a2 polymerizable unsaturated monomers is preferably 85 to 99.9 weight %, more preferably 95 to 99.9 weight %.

In addition, in the synthesis of copolymers A and B (i.e., silane-modified acrylic resin), the ratio of the total amount of (b) a polymerizable surfactant comprising a sulfate having an allyl group and a polyoxyethylene chain in the synthesis process is preferably 0.5 to 5 weight % of the combined weight of the polymerizable unsaturated monomers of a1, a2 and a3 in the copolymer A.

The silane-modified acrylic resin (i.e. aqueous resin emulsion) of the present invention is available, for example, from Henkel Japan Ltd. under the trade name of AQUENCE EPIX BC 21066.

One example of the multistep emulsion polymerization process is described below:

First, a mixture of polymerizable unsaturated monomer A is prepared from (a1) (meth) acrylic acid ester, (a2) a monomer having an alkoxysilyl group and an ethylenic double bond and (a3) a monomer having a carboxyl group in a reaction vessel such as a flask.

Water (or an aqueous medium) is added to a sulfate having an allyl group and a polyoxyethylene chain to obtain an aqueous solution. Then the mixture of the polymerizable unsaturated monomer A is added to this aqueous solution to prepare a monomer emulsion A.

Separately from the monomer emulsion A, a monomer emulsion B is prepared in another vessel. The monomer emulsion B can be prepared using the same method as the above-mentioned method for preparing the monomer emulsion A. Specifically, a mixture of the polymerizable unsaturated monomer B is prepared by mixing (a1) (meth) acrylic acid ester, (a2) a monomer having an alkoxysilyl group and an ethylenic double bond uniformly.

The mixture of the polymerizable unsaturated monomer B is added to the aqueous solution of a sulfate having an allyl group and a polyoxyethylene chain to obtain monomer emulsion B.

Next, water and (b) a sulfate having an allyl group and a polyoxyethylene chain are charged in a reaction vessel equipped with a stirrer, a thermometer and the like, and a part of the monomer emulsion A and a catalyst are added. While maintaining the temperature in the vessel at a suitable temperature, the remainder of the monomer emulsion A and the catalyst are further added dropwise to prepare a pre-emulsion.

By adding the monomer emulsion B and the catalyst dropwise to the pre-emulsion, followed by polymerization, the aqueous resin emulsion, which is a final product, is synthesized by multi-step emulsion polymerization.

Examples of the “catalyst” used in this reaction include ammonium persulfate, sodium persulfate, potassium persulfate, t-butyl peroxybenzoate, 2,2-azobisisobutinitrile (AIBN) and 2,2-azobis(2-amidinopropane) dihydrochloride and 2,2-azobis(2,4-dimethylvaleronitrile) and the like, and ammonium persulfate, sodium persulfate and potassium persulfate are particularly preferable.

The glass transition point (Tg) of the silane-modified acrylic resin used in the present invention is preferably −10 degree C. or higher and 50 degree C. or lower, more preferably 0 degree C. or higher and 50 degree C. or lower. Tg of the copolymer A is preferably lower than Tg of the copolymer B. Tg of the copolymer A is preferably −20 to 20 degree C., more preferably −10 to 20 degree C., and particularly preferably −10 to 15 degree C. Tg of the copolymer B is preferably 10 to 50 degree C., more preferably 25 to 50 degree C., and particularly preferably 30 to 50 degree C.

The minimum film forming temperature (MFT) of the acrylic resin used in the present invention is preferably 25 degree C. or lower, more preferably 0 to 25 degree C. When the minimum film forming temperature (MFT) is 0 to 25 degree C., the solvent barrier property is particularly good.

The Tg and MFT of the acrylic resin are measured by differential scanning calorimetry (DSC).

The high Tg acrylic resin used in the present invention is a non-core shell type acrylic resin, and its glass transition point (Tg) is higher than 50 degree C. and lower than or equal to 95 degree C. The Tg is measured by differential scanning calorimetry (DSC).

The high Tg acrylic resin contains (meth)acrylic acid and a monomer that can be copolymerized with (meth)acrylic acid. The amount of (meth)acrylic acid is preferably from 1 to 10 parts by weight per 100 parts by weight of non-core shell type acrylic resin. The (meth)acrylic acid is soluble in alkali and has a characteristic activity of converting the non-core shell type acrylic resin to a water soluble resin by adding a neutralizer. By converting the non-core shell type acrylic resin to a water soluble resin, the affinity to pigments becomes improved, when a protective layer contains pigments, which makes the protective layer have a superior strength even in the presence of large amount of pigments. The monomer element that can be copolymerized with (meth)acrylic acid includes, for example, alkyl acrylic acid resin, such as methyl(meth)acrylate, ethyl(meth)acrylate, propyl(meth)acrylate, iso-butyl(meth)acrylate, pentyl (meth)acrylate, hexyl (meth)acrylate, 2-ethyl hexyl (meth)acrylate, octyl (meth)acrylate and the like, modified alkyl acrylic acid resin, such as alkyl acrylic acid resin as above that is modified with epoxy resin, silicone resin, styrene or these derivatives, (meth)acrylonitrile, acrylic ester and hydroxy-alkyl acrylic ester. Among these, (meth)acrylonitrile and/or methyl (meth)acrylate are preferred. The amount of (meth)acrylonitrile in the non-core shell type acrylic resin is preferably from 15 to 70 parts by weight per 100 parts by weight of the non-core shell type acrylic resin. And the amount of methyl (meth)acrylate in the non-core shell type acrylic resin is preferably from 20 to 80 parts by weight per 100 parts by weight of the non-core shell type acrylic resin. When both (meth) acrylonitrile and methyl methacrylate are contained, it is preferable to formulate from 15 to 18 parts of (meth) acrylonitrile and from 20 to 80 parts of methyl methacrylate per 100 parts of a non-core shell type acrylic resin.

As the other binder used in the present invention, polyvinyl alcohols, such as completely saponified polyvinyl alcohol, partially saponified polyvinyl alcohol, modified polyvinyl alcohols such as acetoacetylated polyvinyl alcohol, carboxyl-modified polyvinyl alcohol, amide-modified polyvinyl alcohol, sulfonic acid-modified polyvinyl alcohol, butyral-modified polyvinyl alcohol, olefin-modified polyvinyl alcohol, nitrile-modified polyvinyl alcohol, pyrolidone-modified polyvinyl alcohol, silicone-modified polyvinyl alcohol, other modified polyvinyl alcohol and the like; acrylic resins (excluding above-mentioned silane-modified acrylic resin and high Tg acrylic resin) comprising (meth)acrylic acid and a monomer (excluding olefins) that can be copolymerized with (meth)acrylic acid; cellulose derivatives, such as hydroxyethyl cellulose, methyl cellulose, ethyl cellulose, carboxymethyl cellulose, acetyl cellulose and the like; starches, such as oxidized starch, etherified starch, esterified starch and the like; styrene-maleic anhydride copolymer, styrene-butadiene copolymer, casein, gum Arabic, polyvinyl chloride, polyvinyl acetate, polyacrylamide, polyacrylic acid ester, polyvinyl butylal, polystyrol and their copolymers, silicone resins, petroleum resins, terpene resins, ketone resins, cumaron resins and the like may be listed as examples. The polymeric substances may be used upon dissolving them in a solvent such as water, alcohol, ketones, esters, hydrocarbons and the like or upon emulsifying or dispersing into a paste in water or other media. These polymeric materials may also be used in combinations according to the qualities demanded.

The protective layer of the present invention contains a binder (including the above-mentioned silane-modified acrylic resin and high Tg acrylic resin), and may contain other optional components, such as a pigment showed about the thermosensitive recording layer as needed.

The amount of the binder or the combined amount of the binder and the pigment in the protective layer is, in terms of solid content, usually from 80 to 100 weight %, preferably from 90 to 100 weight %. The amount of the binder is preferably about from 30 to 300 parts by weight per 100 parts by weight of the pigment.

The amount of the acrylic resin in the protective layer is preferably from 5.0 to 80.0 weight %, more preferably from 5.0 to 60.0 weight %, and particularly preferably from 15.0 to 50.0 weight % The content of the high Tg acrylic resin in the protective layer is preferably from 5.0 to 50.0 weight %, more preferably from 10.0 to 40.0 weight %.

Each amount of the other components in the protective layer is not more than 15.0 weight %, preferably not more than 10.0 weight %.

The crosslinking agent may be used in combination in the protective layer of the present invention. Such crosslinking agent includes, for example, epichlorohydrin resins such as poly(amine epichlorohydrin) resins, poly(amide epichlorohydrin) resins and the like; modified modified polyamine/amide resins such as polyamide urea resins, polyalkylene polyamine resins, polyalkylene polyamide resins, polyamine polyurea resins, modified polyamine resins, modified polyamide resins, polyalkylene polyamine urea formalin resins, polyalkylene polyamine polyamide polyurea resins, and the like; glyoxal, methylol melamine, melamine formaldehyde resin, melamine urea resin, potassium persulfate, ammonium persulfate, sodium persulfate, ferric chloride, magnesium chloride, borax, boric acid, alums (aluminum potassium sulfate), ammonium chloride, and the like.

It is preferable that the protective layer contains an epichlorohydrin-based resin and a polyamine/polyamide-based resin, which further improves the water resistance.

The thermosensitive recording medium of the present invention may further have an undercoat layer between the substrate and the thermosensitive recording layer.

The undercoat layer comprises mainly a binder and a pigment.

As the binder used for the undercoat layer, commonly used water-soluble polymer or emulsion of hydrophobic polymer may be appropriately used. Specific examples include cellulose derivatives such as polyvinyl alcohol, polyvinyl acetal, hydroxyethyl cellulose, methyl cellulose, carboxymethyl cellulose, etc.; water-soluble polymers such as starch and its derivatives, sodium polyacrylic acid, polyvinylpyrrolidone, acrylic acid amide/acrylic acid ester copolymer, acrylic acid amide/acrylic acid ester/methacrylate copolymer, alkali salt of styrene/maleic anhydride copolymer, alkaliate of isobutylene/maleic anhydride copolymer, polyacrylamide, sodium alginate, gelatin, casein, etc.; emulsion of hydrophobic polymer such as polyvinyl acetate, polyurethane, styrene/butadiene copolymer, polyacrylic acid, polyacrylic acid ester, vinyl chloride/vinyl acetate copolymer, polybutyl methacrylate, ethylene/vinyl acetate copolymer, styrene/butadiene/acrylic copolymer, and the like. These may be used individually and as mixtures of at least two of them.

Any generally used pigment may be used as the pigment in the undercoat layer. As the pigment, for example, inorganic pigment, such as calcium carbonate, silica, zinc oxide, titanium oxide, aluminum hydroxide, magnesium hydroxide, calcined kaolin, clay, talc and the like may be used. These pigments may be used alone or in combination of two or more.

The amount of the pigments in the undercoat layer is ordinarily from 50 to 95 weight parts, preferably from 70 to 90 weight parts per 100 parts by weight of the total solid of the undercoat layer.

Various aids such as a dispersion agent, plasticizer, pH controlling agent, de-foaming agent, water retention agent, preservative, coloring dye, UV absorber and the like may be added to the cating solution for the undercoat layer, as required.

In the present invention, the method for coating the thermosensitive recording layer and other coating layers, such as protective layer and undercoat layer, is not limited in particular, but any known conventional techniques may be used. The method for coating may be appropriately selected from off-machine coating machines and on-machine coating machines, which are equipped with coaters such as air knife coater, rod blade coater, bent blade coater, bevel blade coater, roll coater, curtain coater and the like.

The coating amounts of the thermosensitive recording layer and other coating layers are not limited in particular, but may be determined according to the required performance and the recording suitability. The typical coating amount (in solid) of the thermosensitive recording layer is ordinarily in the range of from 2 to 12 g/m² and the coating amount of the protective layer is preferably in the range of from 0.5 to 5.0 g/m².

Furthermore, various technologies known in the thermosensitive recording medium field, such as a flattening treatment such as super calendaring and the like can be applied as needed after coating individual coating layers.

### EXAMPLES

The following Examples illustrate the present invention, but the Examples are not intended to limit the scope of the present invention. In the following description, the terms parts and % indicate parts by weight and weight %, respectively.

### [Silane-Modified Acrylic Resin]

Each of aqueous emulsions according to Examples was prepared from (A) a monomer emulsion (i.e., copolymer A) and (B) a monomer emulsion (i.e., copolymer B). Polymerizable unsaturated monomers, surfactants and respective additives for the production of (A) and (B) are mentioned below.

Tg of homopolymer of the polymerizable unsaturated monomer is the literature value mentioned above, and Tg of the copolymer of the polymerizable unsaturated monomer (a) and Tg of the copolymer of the polymerizable unsaturated monomer (b) are the values calculated by the previously mentioned theoretical formula.

### <Polymerizable Unsaturated Monomer>

Methyl methacrylate (methyl methacrylate, hereinafter referred to as “MMA” (manufactured by FUJIFILM Wako Pure Chemical Corporation, Tg of homopolymer is 105 degree C.)

2-Ethylhexyl acrylate (2-ethylhexyl acrylate, hereinafter referred to as “2EHA”, manufactured by FUJIFILM Wako Pure Chemical Corporation, Tg of homopolymer is −70 degree C.)

n-Butyl acrylate (n-butyl acrylate, hereinafter referred to as “n-BA” manufactured by FUJIFILM Wako Pure Chemical Corporation, Tg of homopolymer is −54 degree C.)

n-Butyl methacrylate (n-butyl methacrylate, hereinafter referred to as “n-BMA”, manufactured by FUJIFILM Wako Pure Chemical Corporation, Tg of homopolymer is 20 degree C.)

Cyclohexyl methacrylate (cyclohexyl methacrylate, hereinafter referred to as “CHMA”, manufactured by FUJIFILM Wako Pure Chemical Corporation, Tg of homopolymer is 83 degree C.)

3-Methacryloxypropyltrimethoxysilane (manufactured by FUJIFILM Wako Pure Chemical Corporation)

Acrylic acid (hereinafter referred to as “AA”, manufactured by FUJIFILM Wako Pure Chemical Corporation, Tg of homopolymer is 106 degree C.)

Styrene (hereinafter referred to as “St”, manufactured by FUJIFILM Wako Pure Chemical Corporation, Tg of homopolymer is 100 degree C.)

### <Surfactant>

Polyoxyethylene-1-(allyloxymethyl)alkyl ether sulfate ester ammonium salt (Aqualon KH10, manufactured by Dai-ichi Kogyo Seiyaku Co., Ltd., hereinafter referred to as “b”)

### Production Example 1

A monomer emulsion was prepared from a plurality of polymerizable unsaturated monomers, and then a pre-emulsion was prepared from the monomer emulsion and an aqueous resin emulsion was synthesized from the pre-emulsion. Specific processes are as follows.

### (Preparation of (A) Monomer Emulsion)

As shown in Table 1, 5 parts by weight of (a1-1) MMA, 23 parts by weight of (a1-3) BA, 10 parts by weight of (a1-4) BMA, 10 parts by weight of (a1-5) CHMA, 2 parts by weight of (a3) AA, and 0.3 part by weight of (a2) 3-methacryloxypropyltrimethoxysilane were uniformly mixed to prepare a polymerizable unsaturated monomer solution (50.3 parts by weight). To a solution prepared by uniformly mixing 14 parts by weight of water and 0.1 part by weight of (b) a polyoxyethylene-1-(allyloxymethyl)alkyl ether sulfate ester ammonium salt, the above polymerizable unsaturated monomer solution was added, and then the mixed solution was stirred by a stirrer to obtain (A) monomer emulsion.

### (Preparation of (B) Monomer Emulsion)

As shown in Table 1, 16.6 parts by weight of (a1-1) MMA, 13 parts by weight of (a1-3) BA, 10 parts by weight of (a1-4) BMA, 10 parts by weight of (a1-5) CHMA, and 0.1 part by weight of (a2) 3-methacryloxypropyltrimethoxysilane were uniformly mixed to prepare a polymerizable unsaturated monomer solution.

To a solution prepared by uniformly mixing 14 parts by weight of water and 0.1 part by weight of (b) a polyoxyethylene-1-(allyloxymethyl)alkyl ether sulfate ester ammonium salt, the above polymerizable unsaturated monomer solution was added, and then the mixed solution was stirred by a stirrer to obtain (B) monomer emulsion.

### (Synthesis Pre-Emulsion)

In a reactor equipped with a stirrer, a capacitor and a thermometer, 78 parts by weight of water and 1.25 parts by weight of (b) a polyoxyethylene-1-(allyloxymethyl)alkyl ether sulfate ester ammonium salt were charged, and after replacing inside the system with nitrogen gas, the charge solution was heated to 80 degree C.

Subsequently, to the charge solution, the monomer emulsion (A) (which is a portion corresponding to 10.1 parts by weight of the polymerizable unsaturated monomer (a), while whole of the monomer emulsion (A) containing 50.3 parts by weight of the polymerizable unsaturated monomer) and 2 parts by weight of an aqueous 1% by weight sodium persulfate (hereinafter also referred to as “SPS”) solution were added.

After additional 10 minutes, while maintaining the temperature in the reactor at 80 degree C., the remainder of the monomer emulsion (A) (which is a portion corresponding to 40.2 parts by weight of the polymerizable unsaturated monomer (a)) and 4 parts by weight of an aqueous 1% solution of SPS, which is a polymerization catalyst, were simultaneously added dropwise over 2 hours to obtain a pre-emulsion (aqueous resin emulsion based on the polymerizable unsaturated monomer (a)).

### (Synthesis of Aqueous Resin Emulsion)

The temperature in the reactor at 80 degree C. for 30 minutes after completion of the dropwise addition, and then the above monomer emulsion (B) (containing 49.7 parts by weight of the unsaturated polymeric monomer) and 4 parts by weight of an aqueous 1% solution of SPS were simultaneously added dropwise over 2 hours respectively to obtain an aqueous resin emulsion.

The pH of the aqueous resin emulsion thus obtained was adjusted to 8.0 with ammonia water. With respect to the aqueous resin emulsion, the copolymer of the polymerizable unsaturated monomer (A) (i.e., copolymer A) had a glass transition temperature of −3.8 degree C., the copolymer of the polymerizable unsaturated monomer (B) (i.e., copolymer B) had a glass transition temperature of 26.7 degree C., and the aqueous resin emulsion had a solid concentration of 45% by weight. The solid content is the weight percentage of the remaining portion of the aqueous resin emulsion after drying in an oven at 105 degree C. for 3 hours relative to the weight of the aqueous resin emulsion before drying.

The obtained aqueous resin emulsion is referred to as “silane-modified acrylic resin 1”.

### Production Examples 2 to 3

Using the raw material monomers shown in Table 1, the same synthesis was carried out in the same manner as in Production Example 1. The numbers related to the formulation in the table represent parts by weight. The obtained aqueous resin emulsions are referred to as silane-modified acrylic resins 2 to 3, respectively.

TABLE 1

| Production Examples | | |
|---|---|---|
| 1 | 2 | 3 |

Copolymer A

| | | | |
|---|---|---|---|
| (a1) MMA | 5 | 18 | 21 |
| (a1) 2EHA | — | 20 | 22 |
| (a1) BA | 23 | — | — |
| (a1) BMA | 10 | 5 | — |
| (a1) CHMA | 10 | 5 | — |
| (a2) 3-methacryloxypropyltrimethoxysilane | 0.3 | 0.5 | 0.15 |
| (a3) AA | 2 | 2 | 2 |
| St | — | — | 5 |
| Total amount of polymerizable | 50.3 | 50.5 | 50.15 |
| unsaturated monomer(a) | | | |
| Glass transition temperature | −3.8 | 0.93 | 0.8 |
| (Tg, degree C) of copolymer | | | |
| of polymerizable unsaturated | | | |
| monomer(a) | | | |
| (b) polyoxyethylene-1- | 0.1 | 0.1 | 0.9 |
| (allyloxymethyl)alkyl | | | |
| ether sulfate ester | | | |
| ammonium salt | | | |

Copolymer B

| | | | |
|---|---|---|---|
| (a1) MMA | 16.6 | 22 | 33.7 |
| (a1) 2EHA | — | 12.2 | 11 |
| (a1) BA | 13 | | — |
| (a1) BMA | 10 | 10 | — |
| (a1) CHMA | 10 | 5 | — |
| (a2) 3-methacryloxypropyltrimethoxysilane | 0.1 | 0.3 | 0.15 |
| St | — | — | 5 |
| Total amount of polymerizable | 49.7 | 49.5 | 49.85 |
| unsaturated monomer(a) | | | |
| Glass transition temperature | 26.7 | 22.5 | 44.1 |
| (Tg, degree C) of copolymer | | | |
| of polymerizable unsaturated | | | |
| monomer(b) | | | |
| (b) polyoxyethylene-1- | 0.1 | 0.1 | 0.9 |
| (allyloxymethyl)alkyl | | | |
| ether sulfate ester | | | |
| ammonium salt | | | |

in reactor

| | | | |
|---|---|---|---|
| (b) polyoxyethylene-1- | 1.25 | 1.25 | 0.2 |
| (allyloxymethyl)alkyl | | | |
| ether sulfate ester | | | |
| ammonium salt | | | |

Each dispersion and coating solution were prepared as follows for the production of a thermosensitive recording medium.

### [Preparation of Each Coating Solution]

Undercoat layer coating solution was prepared by dispersing and stirring the following formulation:

[Undercoat layer coating solution]

| | |
|---|---|
| Calcined kaolin (BASF Co.: Ansilex 90) | 100.0 parts |
| Styrene-butadiene copolymer latex | 10.0 parts |
| (Zeon Corporation, ST5526, solid | |
| content: 48%) | |
| Water | 50.0 parts |

Each dispersion and coating solution were prepared as follows.

Undercoat layer coating solution was prepared by dispersing and stirring the following formulation:

[Undercoat layer coating solution]

| | |
|---|---|
| Calcined kaolin (BASF Co.: Ansilex 90) | 100.0 parts |
| Styrene-butadiene copolymer latex | 10.0 parts |
| (Zeon Corporation, ST5526, solid | |
| content: 48%) | |
| Water | 50.0 parts |

Color developing agent dispersions (Solutions A1 to A4), a leuco dye dispersion (Solution B) and a sensitizer dispersion (Solution C) with the following formulations were separately wet ground using sand grinders until the average particle sizes were about 0.5 m, and prepared.

Color developing agent dispersion (Solution A1)

| | |
|---|---|
| N,N′-di- [3- (p-toluenesulfonyloxy) phenyl] | 6.0 parts |
| urea (hereinafter referred to | |
| as “urea compound 1”) | |
| Aqueous solution of completely saponified | 5.0 parts |
| polyvinyl alcohol (Kuraray Co., Ltd., | |
| PVA117, solid content: 10%) | |
| Water | 1.5 parts |

Color developing agent dispersion (Solution A2)

| | |
|---|---|
| N-[2-(3-phenylureido) phenyl] benzenesulfonamide | 6.0 parts |
| (hereinafter referred to | |
| as “urea compound 2”) | |
| Aqueous solution of completely saponified | 5.0 parts |
| polyvinyl alcohol (PVA117) | |
| Water | 1.5 parts |

Color developing agent dispersion (Solution A3)

| | |
|---|---|
| Urea compound represented by the formula 9 (Formula 9) (hereinafter referred to as “urea compound 3”) | 6.0 parts |
| [Formula 9] | |

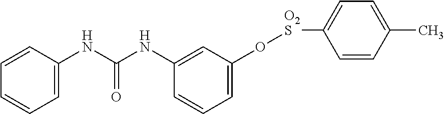 [SMILES: Cc1ccc(S(=O)(=O)Oc2cccc(NC(=O)Nc3ccccc3)c2)cc1]

| | |
|---|---|
| Aqueous solution of completely saponified polyvinyl alcohol (PVA117) | 5.0 parts |
| Water | 1.5 parts |

Color developing agent dispersion (Solution A4)

| | |
|---|---|
| Urea urethane-based compound represented by the following general formula (Formula 13) | |
| (UU manufactured by Fine Ace) | 6.0 parts |
| [Formula 13] | |
| 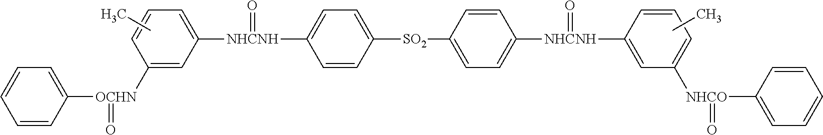 | |
| Aqueous solution of completely saponified polyvinyl alcohol (PVA117) | 5.0 parts |
| Water | 1.5 parts |

Color developing agent dispersion (Solution A5)

| | |
|---|---|
| 4-hydroxy-4′-isopropoxy diphenyl sulfone | 6.0 parts |
| (NYDS manufactured by Mitsubishi Chemical | |
| Corporation) | |
| Aqueous solution of completely saponified | 5.0 parts |
| polyvinyl alcohol (PVA117) | |
| Water | 1.5 parts |

Leuco dye dispersion (Solution B)

| | |
|---|---|
| 3-Dibutylamino-6-methyl-7-anilinofluorane | 6.0 parts |
| (Yamamoto Chemicals Inc., ODB-2) | |
| Aqueous solution of completely saponified | 5.0 parts |
| polyvinyl alcohol (PVA117) | |
| Water | 1.5 parts |

Sensitizer dispersion (Solution C)

| | |
|---|---|
| 1,2-bis(2-Methylphenoxy) ethane | 6.0 parts |
| (Sanko Co. Ltd, KS232) | |
| Aqueous solution of completely | 5.0 parts |
| saponified polyvinyl alcohol (PVA117) | |
| Water | 1.5 parts |

Next, these dispersions were blended in the proportion described below to prepare the thermosensitive recording layer coating solution.

<Thermosensitive recording layer coating solution>

| | |
|---|---|
| Color developing agent dispersion | 18.0 parts |
| (Solution A1) | |
| Color developing agent dispersion | 18.0 parts |
| (Solution A2) | |
| Leuco dye dispersion (Solution B) | 18.0 parts |
| Sensitizer dispersion (Solution C) | 9.0 parts |
| Aqueous solution of completely | 25.0 parts |
| saponified polyvinyl alcohol (PVA117) | |

Next, protective layer coating solution 1 to 3 were prepared by mixing the following formulations:

<Protective layer coating solution 1>

| | |
|---|---|
| Aluminum hydroxide dispersion | 9.0 parts |
| (Martinsberg: Martifin OL, | |
| solid content: 50%) | |
| Silane-modified acrylic resin 1 | 10.0 parts |
| (Tg: 18 degree C, MFT: 22 degree C, | |
| solid content 40%) | |
| Zinc stearate (Chukyo Yushi Co., Ltd.: | 2.0 parts |
| HydrinZ-7-30, solid content: 30%) | |

<Protective layer coating solution 2>

| | |
|---|---|
| Aluminum hydroxide dispersion | 9.0 parts |
| (Martifin OL) | |
| Non-core shell type acrylic resin | 22.2 parts |
| (no silane-modified, styrene acryl, Tg 55 | |
| degree C, MFT 18 degree C, solid content: 18%) | |
| Zinc stearate (Hydrin Z-7-30) | 2.0 parts |

<Protective layer coating solution 3>

| | |
|---|---|
| Aluminum hydroxide dispersion | 9.0 parts |
| (Martifin OL) | |
| Aqueous solution of completely | 40.0 parts |
| saponified polyvinyl alcohol (PVA117) | |
| Zinc stearate (Hydrin Z-7-30) | 2.0 parts |
| Glyoxal (Nippon Synthetic Chemical | 3.0 parts |
| Industry Co., Ltd., solid content: 40%) | |

<Protective layer coating solution 4>

| | |
|---|---|
| Carboxy-modified polyvinyl alcohol solution | 40.0 parts |
| (trade name: KL118 manufactured by Kuraray Co., | |
| Ltd., solid content 10% < degree of polymerization: | |
| about 1700, degree of saponification: 95 to 99 | |
| mol %, sodium acetate: 3% or less) | |
| Poly(amide epichlorohydrin) resin (trade name: | 4.0 parts |
| WS4020 manufactured by Seiko PMC Corporation, | |
| solid content 25%) | |
| Modified polyamine resin (trade name: | 2.2 parts |
| Sumirez Resin SPI-102A manufactured by | |
| Taoka Chemical Co., Ltd., solid content 45%) | |
| Aluminum hydroxide dispersion (Martifin OL) | 9.0 parts |
| Zinc stearate (Hydrin Z-7-30) | 2.0 parts |

### Example 1

The undercoat layer coating solution was applied on one side of a substrate (groundwood free paper with a basis weight of 47 g/m²) by using a bent blade coater with a coating amount (in solid) of 10.0 g/m², and was dried to prepare an undercoated paper.

The thermosensitive recording layer coating solution was applied on the undercoat layer of the undercoated paper by using a rod blade coater with a coating amount (in solid) of 6.0 g/m² and was dried to prepare a thermosensitive recording medium.

Then the protective layer coating solution 1 was applied on the thermosensitive recording layer of the thermosensitive recording layer coated paper by using curtain method with a coating amount (in solid) of 3.0 g/m² and was dried and super calendared so that the smoothness was 100-500 seconds to prepare a thermosensitive recording medium.

### Example 2

A thermosensitive recording medium was prepared in the same manner as described in Example 1 with the exception of changing the silane-modified acrylic resin 1 of the protective layer coating solution 1 to the silane-modified acrylic resin 2.

### Example 3

A thermosensitive recording medium was prepared in the same manner as described in Example 1 with the exception of changing the silane-modified acrylic resin 1 of the protective layer coating solution 1 to the silane-modified acrylic resin 3.

### Example 4

A thermosensitive recording medium was prepared in the same manner as described in Example 1 with the exception of changing the solution A2 of the thermosensitive recording layer coating solution to the solution A3.

### Example 5

A thermosensitive recording medium was prepared in the same manner as described in Example 1 with the exception of changing the solution A1 of the thermosensitive recording layer coating solution to the solution A3.

### Example 6

A thermosensitive recording medium was prepared in the same manner as described in Example 1 with the exception of changing the protective layer coating solution 1 to the protective layer coating solution 2.

### Example 7

A thermosensitive recording medium was prepared in the same manner as described in Example 1 with the exception of changing the formulated amount of Solution A1 to 9 parts and adding 9 parts of Solution A4.

### Example 8

A thermosensitive recording medium was prepared in the same manner as described in Example 1 with the exception of using no Solution A2 and changing the formulated amount of Solution A1 to 36 parts.

### Example 9

A thermosensitive recording medium was prepared in the same manner as described in Example 1 with the exception of using no Solution A1 and changing the formulated amount of Solution A2 to 36 parts.

### Example 10

A thermosensitive recording medium was prepared in the same manner as described in Example 1 with the exception of using no Solution A1 and A2, and adding 36 parts of Solution A3.

### Comparative Example 1

A thermosensitive recording medium was prepared in the same manner as described in Example 4 with the exception of changing the protective layer coating solution 1 to the protective layer coating solution 3.

### Comparative Example 2

A thermosensitive recording medium was prepared in the same manner as described in Example 4 with the exception of changing the protective layer coating solution 1 to the protective layer coating solution 4.

### Comparative Example 3

A thermosensitive recording medium was prepared in the same manner as described in Example 4 with the exception of changing the protective layer coating solution 1 to the protective layer coating solution 3.

### Comparative Example 4

A thermosensitive recording medium was prepared in the same manner as described in Example 4 with the exception that the protective layer was not provided.

### Comparative Example 5

A thermosensitive recording medium was prepared in the same manner as described in Example 8 with the exception that the protective layer was not provided.

### Comparative Example 6

A thermosensitive recording medium was prepared in the same manner as described in Example 5 with the exception that the protective layer was not provided.

### Comparative Example 7

A thermosensitive recording medium was prepared in the same manner as described in Example 1 with the exception of using no Solution A1 and A2, and adding 36 parts of Solution A5.

The prepared thermosensitive recording media were evaluated as below.

### <Color Developing Property (Recorded Density)>

A checkerboard pattern was printed on the prepared thermosensitive recording media by using a thermosensitive recording medium print tester (Okura Engineering Co., Ltd. TH-PMD equipped with a thermal head by Kyocera Co.) at applied energy of 0.41 mJ/dot and printing speed of 50 mm/sec. The density of the printed portion was measured by using Macbeth Densitometer (RD-914, with Amber filter) to evaluate the color developing property (recorded density).

### <Thermal Printing Run-Ability (Prevention of Head Debris)>

Printing of about 60 cm grid was performed on the surface of the prepared thermosensitive recording medium with a label printer from Sato Corporation (Printer name: L′esprit R-8). Head debris stuck to the thermal head after printing was evaluated visually with the following criteria:
Good: Almost no head debris stuck to a thermal head
Fair: Some head debris stuck to a thermal head, but no missing nor blurring of printed images, and no practical problems for use.
Poor: Much sticking of head debris to a thermal head and missing and blurring of printed images observed.

### <High-Speed Thermal Printability>

A barcode (CODE39) is printed on the prepared thermosensitive recording media by using a label printer 140XiIII manufactured by Zebra at the printing level of +10 and the printing speed of 25.4 cm/sec (10 inches/sec) in the vertical direction (i.e., so that the moving direction of the printer head and the barcode are orthogonal to each other.).

Then, the printed barcode is read by a barcode verification machine (Honeywell, QCPC600, light source 640 nm) to evaluate the barcode reading suitability. The evaluation results are shown in the ANSI standard symbol grade.

Symbol grade: The barcode is divided into 10 parts in the direction perpendicular to the bar, and a reading test is performed once at each location, and the average value is represented by a 5-point scale of (excellent) A, B, C, D and F (poor).

### <Oil Resistance>

A checkerboard pattern was painted on the prepared thermosensitive recording media by using a thermosensitive recording medium print tester (Okura Engineering Co., Ltd. TH-PMD equipped with a thermal head by Kyocera Co.) at applied energy of 0.41 mJ/dot and printing speed of 50 mm/sec. Then salad oil was applied on the printed thermosensitive recording media with a cotton swab, which was left for 24 hours. Then the density of the printed portion was measured by using Macbeth Densitometer (RD-914, with Amber filter).

### <Solvent Barrier Property>

Ethanol (99.5%) is applied on the blank portion of the prepared thermosensitive recording medium with a cotton swab, which is then allowed to stand for 24 hours under 23 degree C.×50% RH environmental conditions, and then visually evaluated according to the following criteria.
Good: No color development at all
Fair: Slight color development
Poor: Strong color development

### <Wet Friction>

The surface of the protective layer of the prepared thermosensitive recording medium is rubbed 80 times back and forth with a finger of a tester, which is wetted by tap water. Then the thermosensitive recording medium is visually evaluated if there's peeling observed on the protective layer and the thermosensitive recording layer according to the following criteria.
Good: No peeling observed in the protective layer and the thermosensitive recording layer
Fair: The protective layer is slightly peeled off, while the thermosensitive recording layer is not peeled off.
Poor: Both the protective layer and thermosensitive recording layer are peeled off

### <Water Blocking Resistance>

10 ml of tap water is dropped on the surface of the protective layer of the prepared thermosensitive recording medium, which is then folded in half so that the surface of the protective layer is inside. After a load of 20 gf/cm2 is applied on this for 24 hours, the folded thermosensitive recording medium is opened.

Then the portion of the thermosensitive recording medium on which tap water is dropped is visually evaluated if there's peeling observed on the protective layer and the thermosensitive recording layer according to the following criteria.
Good: No blocking occurs and no peeling observed on the protective layer and the thermosensitive recording layer
Possible: Blocking occurs and the protective layer peels off slightly, while the thermosensitive recording layer causes no peel off.
Poor: Strong blocking occurs and the protective layer and the thermosensitive recording layer are peeled off, or the thermosensitive recording medium is destroyed when opened.

### <Immersion Friction>

The prepared thermosensitive recording medium is immersed in tap water for 10 minutes, then the surface of the protective layer of the thermosensitive recording medium is rubbed 20 times back and forth with a finger of a tester. Then the thermosensitive recording medium is visually evaluated if there's peeling observed on the protective layer and the thermosensitive recording layer according to the following criteria.
Good: No peeling observed in the protective layer and the thermosensitive recording layer
Fair: The protective layer is slightly peeled off, while the thermosensitive recording layer is not peeled off.
Poor: Both the protective layer and thermosensitive recording layer are peeled off

The evaluation results are shown in following Tables.

TABLE 2

| | Exam- | Exam- | Exam- | Exam- | Exam- | Exam- | Exam- | Exam- | Exam- |
|---|---|---|---|---|---|---|---|---|---|
| | ple | ple | ple | ple | ple | ple | ple | ple | ple |
| | 1 | 2 | 3 | 4 | 5 | 6 | 7 | 8 | 9 |
| Color | urea | urea | urea | urea | — | urea | urea | urea | — |
| developing | compound | compound | compound | compound | | compound | compound | compound | |
| agent in | 1 | 1 | 1 | 1 | | 1 | 1 | 1 | |
| thermo- | urea | urea | urea | — | urea | urea | urea | — | urea |
| sensitive | compound | compound | compound | | compound | compound | compound | | compound |
| recording | 2 | 2 | 2 | | 2 | 2 | 2 | | 2 |
| layer | — | — | — | urea | urea | — | — | — | — |
| | | | | compound | compound | | | | |
| | | | | 3 | 3 | | | | |
| | — | — | — | — | — | — | UU | — | — |
| | — | — | — | — | — | — | — | — | — |
| Binder in | silane- | silane- | silane- | silane- | silane- | Non-core | silane- | silane- | silane- |
| protective | modified | modified | modified | modified | modified | shell type | modified | modified | modified |
| layer | acrylic | acrylic | acrylic | acrylic | acrylic | acrylic | acrylic | acrylic | acrylic |
| | resin 1 | resin 2 | resin 3 | resin 1 | resin 1 | resin | resin 1 | resin 1 | resin 1 |
| Color | 1.45 | 1.44 | 1.42 | 1.43 | 1.44 | 1.42 | 1.45 | 1.33 | 1.36 |
| developing | | | | | | | | | |
| property | | | | | | | | | |
| (Recorded | | | | | | | | | |
| density) | | | | | | | | | |
| High-speed | B2.9 | B2.8 | B2.9 | B2.9 | B2.8 | B2.7 | B2.9 | C2.3 | B2.6 |
| thermal | | | | | | | | | |
| printability | | | | | | | | | |
| Thermal | Good | Good | Good | Good | Good | Good | Good | Fair | Good |
| printing | | | | | | | | | |
| run-ability | | | | | | | | | |
| Oil | Good | Good | Good | Good | Fair | Good | Good | Good | Fair |
| resistance | | | | | | | | | |
| Solvent | Good | Good | Good | Good | Good | Fair | Good | Good | Fair |
| barrier | | | | | | | | | |
| property | | | | | | | | | |
| Wet | Good | Good | Good | Good | Good | Good | Good | Good | Good |
| friction | | | | | | | | | |
| Water | Good | Good | Good | Good | Good | Good | Good | Good | Good |
| blocking | | | | | | | | | |
| resistance | | | | | | | | | |
| Immersion | Good | Good | Good | Good | Good | Good | Good | Good | Fair |
| friction | | | | | | | | | |

| | | Comp- | Comp- | Comp- | Comp- | Comp- | Comp- | Comp- |
|---|---|---|---|---|---|---|---|---|
| | Exam- | Exam- | Exam- | Exam- | Exam- | Exam- | Exam- | Exam- |
| | ple | ple | ple | ple | ple | ple | ple | ple |
| | 10 | 1 | 2 | 3 | 4 | 5 | 6 | 7 |
| Color | — | urea | urea | urea | urea | urea | — | — |
| developing | | compound | compound | compound | compound | compound | | |
| agent in | | 1 | 1 | 1 | 1 | 1 | | |
| thermo- | — | — | — | — | — | urea | urea | — |
| sensitive | | | | | | compound | compound | |
| recording | | | | | | 2 | 2 | |
| layer | urea | urea | urea | urea | — | — | urea | — |
| | compound | compound | compound | compound | | | compound | |
| | 3 | 3 | 3 | 3 | | | 3 | |
| | — | — | — | — | — | — | — | — |
| | — | — | — | — | — | — | — | NYDS |
| Binder in | silane- | completely | Carboxy- | none | none | none | none | silane- |
| protective | modified | saponified | modified | | | | | modified |
| layer | acrylic | PVA | PVA | | | | | acrylic |
| | resin 1 | | | | | | | resin 1 |
| Color | 1.38 | 1.32 | 1.33 | 1.48 | 1.37 | 1.49 | 1.48 | 1.39 |
| developing | | | | | | | | |
| property | | | | | | | | |
| (Recorded | | | | | | | | |
| density) | | | | | | | | |
| High-speed | B2.6 | D1.3 | D1.1 | B2.8 | B2.6 | B2.9 | B2.9 | B2.5 |
| thermal | | | | | | | | |
| printability | | | | | | | | |
| Thermal | Good | Fair | Good | Poor | Poor | Poor | Poor | Poor |
| printing | | | | | | | | |
| run-ability | | | | | | | | |
| Oil | Fair | Good | Good | Fair | Fair | Fair | Poor | Poor |
| resistance | | | | | | | | |
| Solvent | Good | Fair | Good | Poor | Poor | Poor | Poor | Poor |
| barrier | | | | | | | | |
| property | | | | | | | | |
| Wet | Good | Poor | Fair | Poor | Poor | Poor | Poor | Good |
| friction | | | | | | | | |
| Water | Good | Poor | Poor | Poor | Poor | Poor | Poor | Fair |
| blocking | | | | | | | | |
| resistance | | | | | | | | |
| Immersion | Fair | Poor | Poor | Poor | Poor | Poor | Poor | Poor |
| friction | | | | | | | | |

1-16. (canceled)

17. A thermosensitive recording medium having:
a thermosensitive recording layer comprising:
a colorless or pale colored electron donating leuco dye; and
an electron accepting color developing agent on a substrate; and
a protective layer on the thermosensitive recording layer,
wherein the thermosensitive recording layer contains at least one kind of urea compound as the electron accepting color developing agent, and wherein the protective layer contains an acrylic resin,
wherein the minimum film forming temperature (MFT) of the acrylic resin is 0 degrees C. to 25 degree C.,
wherein the urea compound is selected from the group consisting of the following (1) to (3),
(1) a first urea compound represented by the following general formula (Formula 6) 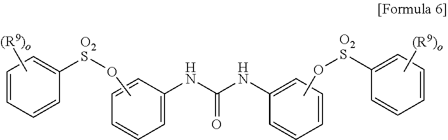
wherein R⁹ may be identical or different from each other and represent an alkyl group or an alkoxy group, and o represents an integer of 0 to 3,
(2) a second urea compound represented by the following general formula (Formula 8) 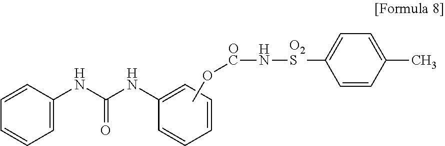
(3) a third urea compound represented as N-[2-(3-phenylureido) phenyl]benzenesulfonamide.

18. The thermosensitive recording medium of claim 17, wherein the thermosensitive recording layer contains at least two kinds of urea compounds selected from the group consisting of the (1) to (3) as the electron accepting color developing agent, provided that two or more kinds are not selected from each of (1), (2) or (3).

19. The thermosensitive recording medium of claim 17, wherein the protective layer comprises any of two kinds of the following acrylic resins as the acrylic resin,
(4) a non-core shell type acrylic resin with a glass transition temperature (Tg) of higher than 50 degree C. and lower than or equal to 95 degree C., and
(5) a silane-modified acrylic resin that is an aqueous emulsion of core-shell type particles, wherein the core-shell type particle comprises a core comprising copolymer A prepared by polymerizing the following (a1), (a2) and (a3) in the presence of (b), and a shell comprising copolymer B prepared by polymerizing the following (a1) and (a2) in the presence of (b),
(a1) at least one (meth)acrylic acid ester,
(a2) a monomer having an alkoxysilyl group and an ethylenic double bond,
(a3) a monomer having a carboxyl group and an ethylenic double bond, and
(b) a polymerizable surfactant comprising a sulfate having an allyl group and a polyoxyethylene chain.

20. The thermosensitive recording medium of claim 17, wherein in the first urea compound, wherein R⁹ represents an alkyl group having 1 to 4 carbon atoms, o represents an integer of 0 to 1, and the position of R⁹ in the benzene ring is the 4-position.

21. The thermosensitive recording medium of claim 17, wherein the content, in solid, of the urea compound in the thermosensitive recording layer is from 1.0 to 70.0 weight %.

22. The thermosensitive recording medium of claim 21, wherein the content, in solid, of the first urea compound in the thermosensitive recording layer is from 1.0 to 50.0 weight %, provided that the total content, in solid, of the first to third urea compounds used is within the above-described range.

23. The thermosensitive recording medium of claim 21, wherein the content, in solid, of the second urea compound in the thermosensitive recording layer is from 5.0 to 50.0 weight %, provided that the total content, in solid, of the first to third urea compounds used is within the above-described range.

24. The thermosensitive recording medium of claim 21, wherein the content, in solid, of the third urea compound in the thermosensitive recording layer is from 5.0 to 50.0 weight %, provided that the total content, in solid, of the first to third urea compounds used is within the above-described range.

25. The thermosensitive recording medium of claim 17, wherein the thermosensitive recording layer contains a color developing agent other than the first urea compound, the second urea compound and the third urea compound, and the combined amount, in solid, of the first urea compound, the second urea compound and the third urea compound is 90 weight % or more of the total amount of the color developing agent contained in the thermosensitive recording layer.

26. The thermosensitive recording medium of claim 17, wherein the content, in solid, of the acrylic resin in the protective layer is 15.0 to 50.0 weight %.
